(19) United States
(12) Patent Application Publication
(10) Pub. No.: US 2006/0178940 A1
(43) Pub. Date: Aug. 10, 2006

(54) Open house information system

(75) Inventors: Jonathan Taylor, Glenside, PA (US); Milford H. Balaban, Blue Bell, PA (US)

Correspondence Address: KENYON & KENYON LLP, 1500 K STREET N.W., SUITE 700, WASHINGTON, DC, 20005, US

(73) Assignee: IDS Identification & Safety Systems, LLC

(21) Appl. No.: 11/022,687

(22) Filed: Dec. 28, 2004

(51) Int. Cl. G06Q 30/00

(52) U.S. Cl. 705/26

(57) ABSTRACT

Information is received that has been electronically read in a machine-readable format stored on a driver's license presented by a visitor to the open house is used to derive the name of the visitor. A telephone number of the visitor is derived based on the received information. An open house report is generated that includes the name and the telephone number of the visitor.

### BACKGROUND OF THE INVENTION

A property for sale or lease made available to the public for inspection is called an “open house.” The open house is “listed” for sale by a realty company that can have a local office. A sales agent associated with the listing realty company can be present at the open house to monitor the open house and to help sell the property. The sales agent can facilitate the sale of the property by answering questions posed by visitors and providing them with written material describing the property and aspects of the sale.

Visitors to certain known open houses are requested to manually provide their names and contact information (e.g., names, addresses, telephone numbers, e-mail addresses, etc.) by writing them on a “sign-in sheet.” The sign-in sheet often is comprised of a table having columns labeled “name”, “address”, “telephone number”, “e-mail address”, etc. Such contact information can be useful to the realtor and realty company conducting the open house in keeping visitors apprised of the sales status of the open house (e.g., still for sale, under contract, sold, etc.) and for marketing other properties to the visitors. It is also useful for tracking visitors to an open house in case there is a theft or breakage.

Some visitors to an open house are reluctant to write down their contact information on the sign-in sheet because it is inconvenient or because they do not wish to share it with the sales agent and/or realty company. A visitor can provide false or incomplete information on the sign-in sheet rather than openly refuse a request by the sales agent to complete provide their contact information. Without accurate visitor contact information, there is often no way in which to identify and hold accountable a visitor responsible for theft or breakage. For at least the foregoing reasons, what is needed is a more reliable way to gather visitor information at open houses.

### BRIEF DESCRIPTION OF THE DRAWINGS

FIG. 1 shows a system in accordance with an embodiment of the present invention.

FIG. 2 is a flow chart that shows a method in accordance with an embodiment of the present invention.

### DETAILED DESCRIPTION

In accordance with an embodiment of the present invention, a card reader at an open house can read information stored in a machine-readable format on a card presented by a visitor to extract visitor contact information, such as the visitor's name, address information (e.g., postal address, e-mail address, etc.), etc. A card can be a government-issued instrument, such as a driver's license, a passport, a national identity card, etc., or a privately-issued instrument, such as a company identification card, a shopping card, a credit card, etc. Visitor contact information can be extracted directly from data stored on the card or else found by querying an appropriate database based on data stored on the card. For example, a postal address can be electronically read from a driver's license and used as the basis of a query to a database storing postal address and telephone number information. In that way, a telephone number can be correlated with the postal address. Likewise, name and postal address data extracted from a card such as a driver's license can be correlated with an e-mail address by querying the appropriate database. In this way, a record of visitor contact information can be built beyond the data stored on the card. As used herein, “visitor data” includes that information stored on a visitor card. “Visitor information” can include the information stored on a visitor card and can also include other information that can be associated with the visitor based upon the visitor card data. Each record of visitor information can include visitor name, postal address, telephone number, e-mail address, date of birth and any other data stored on the card and any other information useful to add to the record.

The card reader at the open house can be provided by the sales agent or any other suitable entity. It can include a keypad that can be used to enter an access code to activate the card reader; a sales agent or realty company code to serve as the basis for correlating subsequently gathered visitor contact information with the sales agent, realty company, realty company office and/or the open house itself; a price range within which the open house property is offered for sale; the price at which the property is offered for sale; etc. The card reader can read data stored on cards in a magnetic, optical and/or other machine-readable format. The sales agent can cause his own card to be read at the open house.

The sales agent contact information extracted from the card can be used as the basis for correlating visitor contact information gathered at the open house with the sales agent, a realty company, a realty company office and/or the open house. For example, the sales agent contact information can be associated with the visitor contact information read on the same day, in a several hour period immediately following the time at which the sales agent card is read, or in accordance with any other rule suitable for correlating visitor contact information with a sales agent or open house.

A sales agent can verify that a card presented by a visitor actually belongs to that visitor by comparing a picture on the card to the visitor, or by asking for corroborating identification that matches that on the card.

Privacy concerns of a visitor can be assuaged by formulating and posting a privacy policy at the open house. For instance, such a privacy policy can assure the visitor that the data read from the visitor's card will only be used by the realty company and its representatives and not be distributed outside of the realty company. The visitor can be provided the opportunity to “opt in” to programs in which the visitor contact information is shared with entities outside of the realty company, e.g., by entering such an election to opt-in via the card reader keypad.

An open house report can be generated based on the visitor contact information. An open house report can be generated and printed locally at the open house based upon the data read from visitors' cards and can include visitor records each of which can include names and telephone numbers of visitors. A visitor record can also include any other elements of visitor information based upon data stored on the card or that is useful to include in a visitor record.

Visitor information can be forwarded to a processing center. The information can be forwarded as it is received, or can be sent later, e.g., along with other accumulated visitor information. At the central location, the visitor information can be augmented by correlating additional information to each visitor record. A visitor record can be augmented by querying an appropriate database based upon visitor data obtained from the visitor card; based upon visitor information already obtained from one or more databases; or added for convenience, e.g., the postal address of the open house can be added, as can the name of the sales agent, the identity of the realty company, etc.

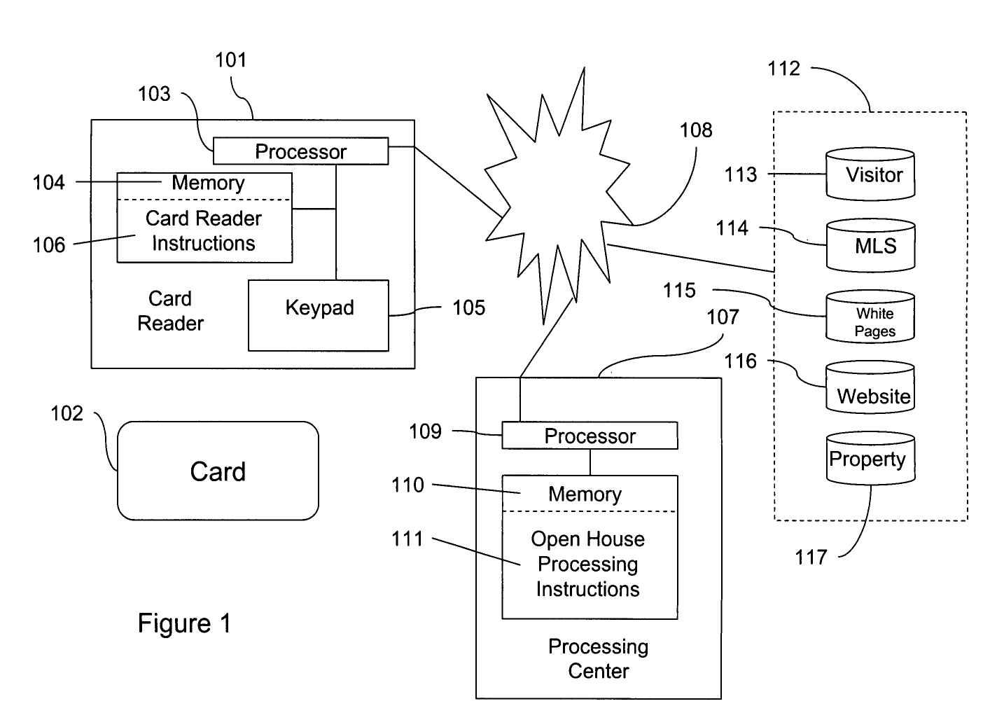

A system in accordance with an embodiment of the present invention is shown in FIG. 1. A card reader 101 situated at an open house can read the data stored on visitor card 102. Card reader 101 can read data stored on magnetic stripes and/or optical codes (e.g., a bar code or glyph), stored in the memory of a smart card, etc. Any card 102 that stores data in a machine-readable format can be suitable, such as a driver's license, smart card, credit card, shopper's card, etc. Card reader 101 can include processor 103 coupled to memory 104 and optional keypad 105, memory 104 storing card reader instructions 106 adapted to read data from card 102.

In one embodiment, card reader instructions 106 executing on processor 103 can recognize predetermined types of contact information (e.g., name, address, telephone, e-mail, etc.) in different formats in which it can be stored on different cards 102. In one embodiment, such contact information can be extracted by the card reader by consulting a table containing descriptions of each format of a plurality of different cards correlated with an identifier for the card. For example, a State identifier can be automatically read from a driver's license or else entered manually through an optional keypad 105 at the card reader 101. The card reader can look up the format (e.g., last name, first name, license number, driver's street name, etc.) and extract the desired contact information. For example, the realty company may only seek name and postal address, and the reader 101 may thus not extract the license number or other data stored on the license.

In another embodiment, data stored on the card 102 can be initially extracted and then parsed by card reader instructions 106 executing on processor 103 to identify first name, last name, street name, etc. For example, a first name can be recognized by comparing the data extracted from the card 101 to a database of known first names. If the contents of a field from the card match a first name in the table, then the field is tagged as a possible first name field. The contents of an adjacent field can similarly be compared with a last name field. Likewise, fields containing fewer than the minimum number of digits in any State's license identifier can be candidate street numbers. Adjacent fields can be parsed as street name fields, terminated by a field containing a street type identifier, such as “RD”, “ST”, “Road”, Street”, etc. In this way, visitor contact information can be parsed from the card 102 and sent to a processing center 107, e.g., via a network 108, such as the Internet, the Public Switched Telephone Network (PSTN), a Virtual Private Network (VPN), etc. Alternatively, all of the contact information can be gathered from the card 101 by the card reader 102 and send to be parsed at processing center 107.

Information can also be sent from card reader 101 that can be used to correlate visitor contact information with a particular open house. For example, each card reader 101 can have a unique identifier. The unique identifier can be correlated with a given realty office, realty company, sales agent and/or open house. The unique identifier and/or event (e.g., card read) time and date information can be sent to processing center 107. Such information can be useful in building visitor information records and generating an open house report.

In one embodiment, an open house can be registered to the processing center 107 through a web site. An open house registration can include sales agent, realty company, realty company office and/or open house identifiers; a card reader 102 identifier; and/or information about the open house such as the identity of the property (e.g., MLS listing number, postal address, etc.), pricing information for the open house property and schedule information such as the date and time range over which the Open House is held.

When processing center 107 receives from card reader 102 visitor information along with identifier information, it can augment the visitor information and/or generate the open house report by using the identifier to access information stored in the open house registration record.

Processing center 107 can include a processor 109 coupled to memory 110 storing open house processing instructions 111 and coupled to one or more databases 112, e.g., through network 108 or directly (not shown.) Databases 112 can include a visitor information database 113 storing visitor information records, the Multiple Listing Service (“MLS”) database 114, a white pages database 115 correlating name, address and telephone information, websites on the Internet 116, municipal property record databases 117, and any other database (not shown) whose information would be useful to include in an open house report.

All or part of card reader instructions 106 and/or open house processing instructions 110 can be distributed by a software maker, seller, distributor and/or user stored on a medium capable of storing digital information, such as flash memory, a CD ROM or a sending hard disk coupled to a receiving hard disk through a network such as the Internet.

In one embodiment, the information contained in an open house visitors report can be built and/or accessed by a sales agent any suitable person through a graphical user interface provided on a website that can be coupled to processing center 107. For example, a user can specify the elements of information that the open house report should contain (e.g., name and telephone numbers only; names and addresses only; e-mail addresses only; etc.) and the format. thereof, e.g., by selecting one of several predetermined format templates for the report. A user can specify to whom a copy of the open house report can be sent and how it should be sent, e.g., via e-mail or facsimile. A user can also set access permissions, e.g., select persons from a list to whom to give permission to view and/or modify and/or print a given open house report. Similarly, a user can simply view an open house report over the web, and add or hide various fields (e.g., name, address, asking price, open house address, etc.) in the open house report.

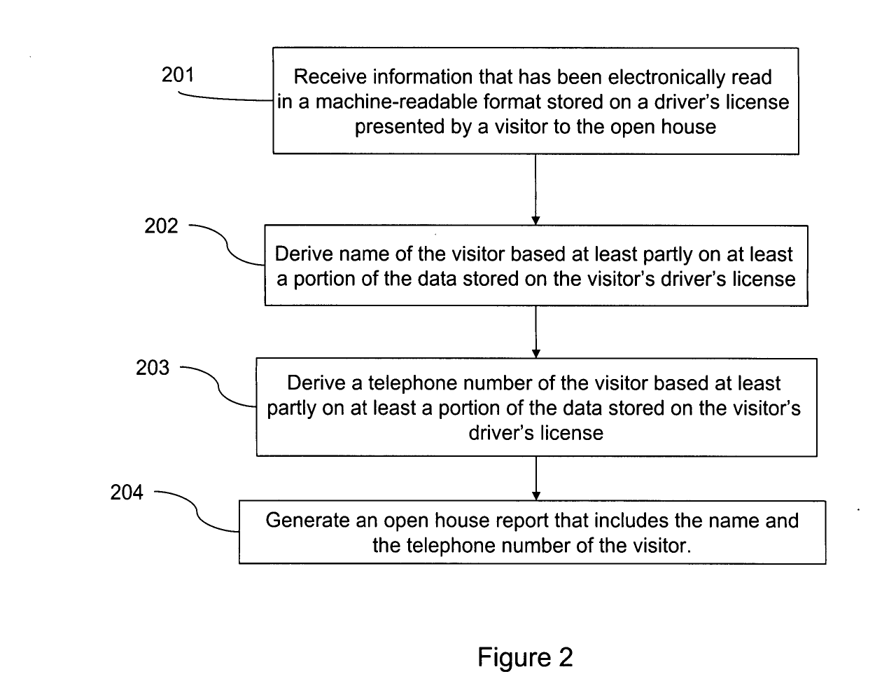

A method in accordance with an embodiment of the present invention is shown in FIG. 2. Information is received that has been electronically read in a machine-readable format stored on a driver's license presented by a visitor to the open house, step 201. The name of the visitor is derived based at least partly on at least a portion of the data stored on the visitor's driver's license, step 202. A telephone number of the visitor is derived based at least partly on at least a portion of the data stored on the visitor's driver's license, step 203. An open house report is generated that includes the name and the telephone number of the visitor, step 204.

Other useful embodiments of the present invention include a building security system. Certain known building security systems use custom-made cards storing machine readable data, where the cards are issued by a security company. In accordance with an embodiment of the present invention, a card reader electronically reads data in a machine-readable format stored on a driver's license presented by a visitor seeking to access the building. A visitor information record based upon the data read from the card and sent to a processing center over a network such as the Internet. The visitor information can be digitally signed and/or encrypted as known in the art prior to being sent to protect its integrity and confidentiality. The processing center can verify the digital signature and/or decrypt the visitor information and augment the visitor information record by using the received visitor information to query one or more databases and/or add other information, e.g., regarding the identity, address, etc. of the building. The visitor information record can be compared to an appropriate access list, and an electronic signal can be sent from the processing center to the building indicating that the visitor may or may not access the building and/or electronically open a lock and/or activate a camera to take a picture of or videotape the visitor and/or take any other suitable action.

Another embodiment of the present invention can be used to enhance the security of automobile dealerships that permit visitors to test drive vehicles for sale. In this sense, a vehicle made available to test drive is analogous to an open house, and the functions provided as described above for an open house may be performed for test drivers. A card reader at the dealership can electronically read data stored in machine-readable format on the driver's license to create a test driver information record. The test driver information record can be sent to a processing center that can obtain related information by querying the appropriate database, such as a credit card number of the test driver that can be used to secure the dealership against any damage to or theft of the test drive vehicle. A criminal record check can also be performed based upon the received test driver information, and the results sent back to the dealership before the test driver is permitted to test drive the vehicle.

Yet another embodiment of the present invention can be used to enhance the security of banking activities. In certain known systems, a customer presents a bank-issued debit card and enters a Personal Identification Number (“PIN”) through a keypad to authenticate himself to the bank. However, not every person doing business with the bank has such a bank card, and some of those that do may occasionally forget to bring it and still want to be authenticated.

In accordance with an embodiment of the present invention, a customer at a bank can be asked to present a card other than one issued by the bank, such as his driver's license, passport or national identity card. This can be used analogously to the way a driver's license is used in connection with the open house embodiment described above. For example, a card reader at a teller or bank officer's station can be used to electronically read data stored in machine-readable format on the driver's license to create a customer information record. The customer information record can be sent to a processing center that can obtain related information by querying an appropriate database, such as personal information that the customer has registered to provide a means to authenticate the customer. For example, the customer can have registered a secret password, his mother's maiden name, the city of his birth, etc. This secret can be shared with the teller or bank officer seeking to authenticate the customer. The teller or bank officer can ask the customer to provide the secret. If the customer provides the correct secret, then the customer can be said to be authenticated. Other ways to use this embodiment of the present invention is to fetch a written or graphic description of the customer's face from a database based upon the customer information record built from the data read from the driver's license, to fetch biometric information (such as iris data, fingerprint data, retina data, etc.) and to compare it with biometric data obtained from the customer when he is before the teller or officer, etc.

The above description is meant to illustrate and not to limit the scope of the present invention, which one of ordinary skill in the art will understand encompasses other embodiments besides the examples discussed above.

What is claimed is:

1. A method for processing visitor information at an open house, comprising:
receiving information that has been electronically read in a machine-readable format stored on a driver's license presented by a visitor to the open house;
deriving the name of the visitor based at least partly on at least a portion of the data stored on the visitor's driver's license;
deriving a telephone number of the visitor based at least partly on at least a portion of the data stored on the visitor's driver's license; and
generating an open house report that includes the name and the telephone number of the visitor.

2. The method of claim 1, wherein the name of the visitor is derived by reading the name stored on the visitor driver's license.

3. The method of claim 1, wherein the name of the visitor is derived by reading address data stored on the driver's license and querying a database having name and address information based on the driver's license address data to obtain the name.

4. The method of claim 1, wherein the telephone number of the visitor is derived by reading address data stored on the visitor driver's license and querying a database having telephone number and address information based on the driver's license address data to obtain the telephone number.

5. The method of claim 1, wherein the open house report is sent to at least one from the group of: a sales agent, a realty company headquarters and a realty company local office.

6. The method of claim 1, further including receiving a price range within which the open house property is offered for sale.

7. The method of claim 1, further including correlating the information received from the visitor's driver's license to at least one from the group of a sales agent, a realty company, a realty company office and an open house.

8. The method of claim 1, further including correlating the information received from the visitor's driver's license with a realty company.

9. A method for processing visitor information at an open house, including generating an open house report that includes names and telephone numbers of visitors to the open house, wherein the name and telephone number of a visitor is derived from data stored in a machine-readable format on a driver's license presented by the visitor at the open house, said stored information being electronically read from the driver's license at the open house.

10. The method of claim 9, wherein the name of the visitor is stored in a machine-readable format on the driver's license, and the name is derived by electronically reading it from the driver's license.

11. The method of claim 9, wherein the name of a visitor is derived by reading address data stored on the visitor's driver's license and querying a database having name and address information based on the address information obtained from the driver's license.

12. The method of claim 9, wherein the telephone number of the visitor is derived by reading address data stored on the driver's license and querying a database having telephone number and address information based on the address data obtained from the driver's license.

13. A medium storing instructions adapted to be executed by a processor to perform steps including:
receiving information that has been electronically read in a machine-readable format stored on a driver's license presented by a visitor to the open house;
deriving the name of the visitor based at least partly on at least a portion of the data stored on the visitor's driver's license;
deriving a telephone number of the visitor based at least partly on at least a portion of the data stored on the visitor's driver's license; and
generating an open house report that includes the name and the telephone number of the visitor.

14. A medium storing instructions adapted to be executed by a processor to generate an open house report that includes names and telephone numbers of visitors to the open house, wherein the name and telephone number of a visitor has been electronically read in a machine-readable format stored on a driver's license presented by the visitor at the open house.
